(19) United States
(12) Patent Application Publication
(10) Pub. No.: US 2007/0085463 A1
(43) Pub. Date: Apr. 19, 2007

(54) Electron emission display device

(76) Inventors: Sang-Ho Jeon, Suwon-si (KR); Chun-Gyoo Lee, Suwon-si (KR); Sang-Jo Lee, Suwon-si (KR); Su-Bong Hong, Suwon-si (KR); Sang-Hyuck Ahn, Suwon-si (KR)

Correspondence Address: Robert E. Bushnell, Suite 300, 1522 K. Street, N.W., Washington, DC, 20005-1202, US

(21) Appl. No.: 11/545,540

(22) Filed: Oct. 11, 2006

(30) Foreign Application Priority Data
Oct. 19, 2005 (KR) 10-2005-0098505

(51) Int. Cl. H01J 1/00; H01J 19/06

(52) U.S. Cl. 313/311

(57) ABSTRACT

An electron emission display device includes a first substrate and a second substrate facing each other, a side member formed along edges of the first substrate and the second substrate to form a vacuum envelope together with the first substrate and the second substrate, an electron emission unit provided on the first substrate, a light emission unit provided on the second substrate for emitting visible light by means of electrons from the electron emission unit, and a conductive layer formed on at least a partial exterior surface of the vacuum envelope and connected to a ground voltage for discharging static charge accumulated in the vacuum envelope.

### CLAIM OF PRIORITY

This application makes reference to, incorporates the same herein, and claims all benefits accruing under 35 U.S.C. §119 from an application for ELECTRON EMISSION DISPLAY DEVICE earlier filed in the Korean Intellectual Property Office on the 19^{th} of Oct. 2005 and there duly assigned Serial No. 10-2005-0098505.

### BACKGROUND OF THE INVENTION

1. Technical Field

The present invention relates to an electron emission display device and, in particular, to a structure which discharges static charges accumulated in a vacuum envelope.

2. Related Art

In general, electron emission elements are classified into a first type wherein a hot cathode is used as an electron emission source and a second type wherein a cold cathode is used as the electron emission source.

A vacuum fluorescent display (VFD) uses the first type of electron emission element.

Among the second type of electron emission elements, a field emission array (FEA) type, a surface-conduction emission (SCE) type, a metal-insulator-metal (MIM) type, and a metal-insulator-semiconductor (MIS) type are known.

The MIM-type and the MIS-type electron emission elements have electron emission regions with a metal/insulator/metal (MIM) structure and a metal/insulator/semiconductor (MIS) structure, respectively. When voltages are applied to the two metals or to the metal and the semiconductor on respective sides of the insulator, electrons supplied by the metal or semiconductor on the lower side pass through the insulator due to a tunneling effect and arrive at the metal on the upper side. Of the electrons that arrive at the metal on the upper side, those that have energy greater than or equal to the work function of the metal on the upper side are emitted from the upper electrode.

The SCE-type electron emission element comprises a thin conductive film formed between first and second electrodes which are arranged facing each other on a substrate. Micro-crack electron emission regions are positioned on the thin conductive film. When voltages are applied to the first and second electrodes and an electric current is applied to the surface of the conductive film, electrons are emitted from the electron emission regions.

The FEA-type electron emission element comprises an electron emission region, a cathode electrode and a gate electrode as driving electrodes controlling the electron emission region. The electron emission region is made from materials having low work functions or high aspect ratios so as to emit electrons easily when exposed to an electric field in a vacuum atmosphere. A front sharp-pointed tip structure based on molybdenum (Mo) or silicon (Si), or a carbonaceous material such as carbon nanotube, graphite and diamond-like carbon, is used as the electron emission region.

Arrays of the electron emission elements are formed on a substrate to make an electron emission device, and the electron emission device is assembled with a second substrate having a light emission unit based on phosphor layers, an anode electrode, etc., thereby constructing an electron emission display device.

That is, a common electron emission device includes electron emission regions together with driving electrodes functioning as scan and data electrodes so as to control the quantity of electron emission and the ON/OFF states of electron emission per pixel by operation of the electron emission regions and the driving electrodes. The electron emission display device excites phosphor layers by means of electrons emitted from the electron emission regions, thereby performing a predetermined light emission or image display.

The electron emission regions in each pixel emit electrons continuously, and the electrons are attracted by the high voltage applied to the anode electrode, thereby colliding against the phosphor layers.

Due to the repetition of this kind of operation, static charge is continuously accumulated in a vacuum envelope.

In particular, the anode electrode is supplied with a high voltage ranging from several hundred to several thousand volts so as to sufficiently accelerate the electrons, which facilitates charging of the static charge in the vacuum envelope.

The static charge accumulated in the vacuum envelope degrades the phosphor layers, causes damage to the phosphor layers, and provides an indirect cause of arcing which occurs inside the vacuum envelope when the static charge receives the energy of the high voltage which is applied to the anode electrode. The arcing fatally damages the driving electrodes formed in the vacuum envelope, and causes trouble in the operation of the electron emission display device.

### SUMMARY OF THE INVENTION

In one exemplary embodiment of the present invention, an electron emission display device prevents static charge from being charged in the vacuum envelope.

In an embodiment of the present invention, the electron emission display device includes a first substrate and a second substrate facing each other, a side member formed along edges of the first substrate and the second substrate so as to form a vacuum envelope together with the first substrate and the second substrate, an electron emission unit provided to the first substrate, a light emission unit provided to the second substrate so as to emit visible light by electrons from the electron emission unit, and a conductive layer formed on at least a partial exterior surface of the vacuum envelope and connected to a ground voltage so as to discharge static charge accumulated in the vacuum envelope.

The conductive layer may be formed on one of the first and second substrates, or it may be formed on the first and second substrates together. The conductive layer may be additionally formed on the outer side surface of the side member, it may be formed external to an active area set up in the second substrate, and it may be formed on the entire surface of the second substrate including the active area in the case of the conductive layer being formed so as to be transparent.

The conductive layers respectively formed on the first substrate, the second substrate, and the sealing member may be connected continuously.

The conductive layer may include at least one material selected from the group consisting of aluminium (Al), silver (Ag), copper (Cu), gold (Au), molybdenum (Mo), and graphite. The conductive layer may be made of adhesive tape, and it may have a specific resistance in the range of 0.1 to 100 Ωcm.

The electron emission unit may include an electron emission region and a driving electrode controlling the electron emission region. The driving electrode may include a cathode electrode and a gate electrode which are insulated from each other while intersecting.

The electron emission region may include at least one material selected from the group consisting of carbon nanotubes, graphite, graphite nanofiber, diamond, diamond-like carbon, fullerene (C₆₀), silicon nanowire, and combinations thereof.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view schematically showing an electron emission display device according to a first embodiment of the invention.

FIG. 2 is a planar view of the electron emission display device shown in FIG. 1.

FIG. 3 is a cross-sectional view schematically showing an electron emission display device according to a second embodiment of the invention.

FIG. 4 is a cross-sectional view schematically showing an electron emission display device according to a third embodiment of the invention.

FIG. 5 is a cross-sectional view schematically showing an electron emission display device according to a fourth embodiment of the invention.

FIG. 6 is a cross-sectional view showing a field emission array (FEA) type of electron emission display device.

FIG. 7 is a cross-sectional view showing a surface-conduction emission (SCE) type of electron emission display device.

### DETAILED DESCRIPTION OF THE INVENTION

With reference to the accompanying drawings, the present invention will be described in order for those skilled in the art to be able to implement it. As those skilled in the art would realize, the described embodiments may be modified in various different ways, all without departing from the spirit or scope of the present invention. Wherever possible, the same reference numbers will be used throughout the drawing(s) to refer to the same or like parts.

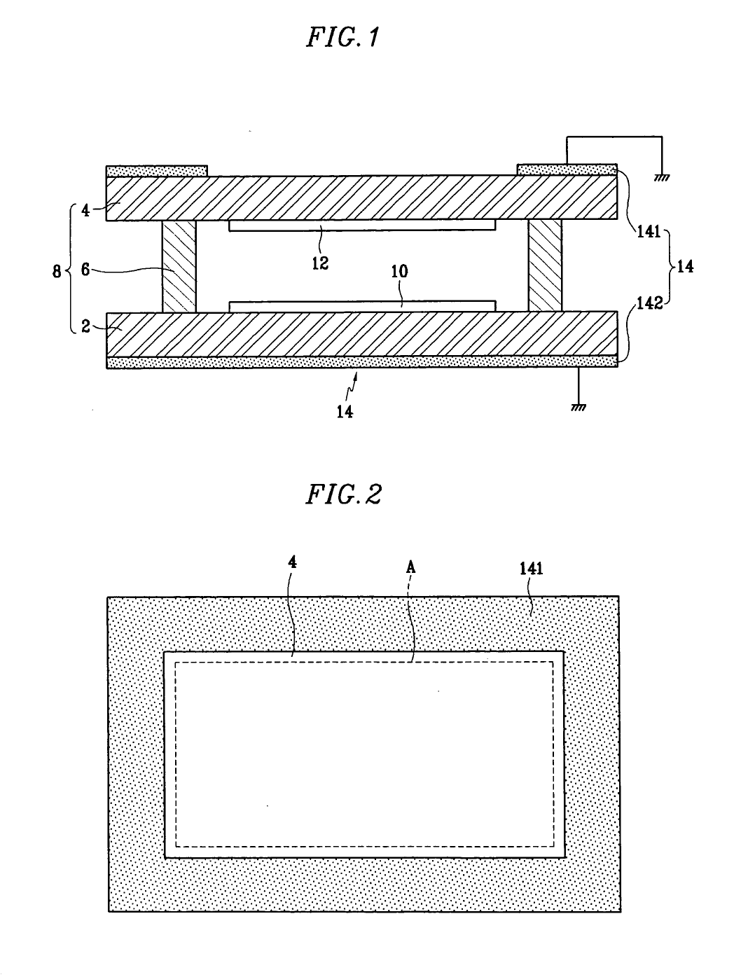

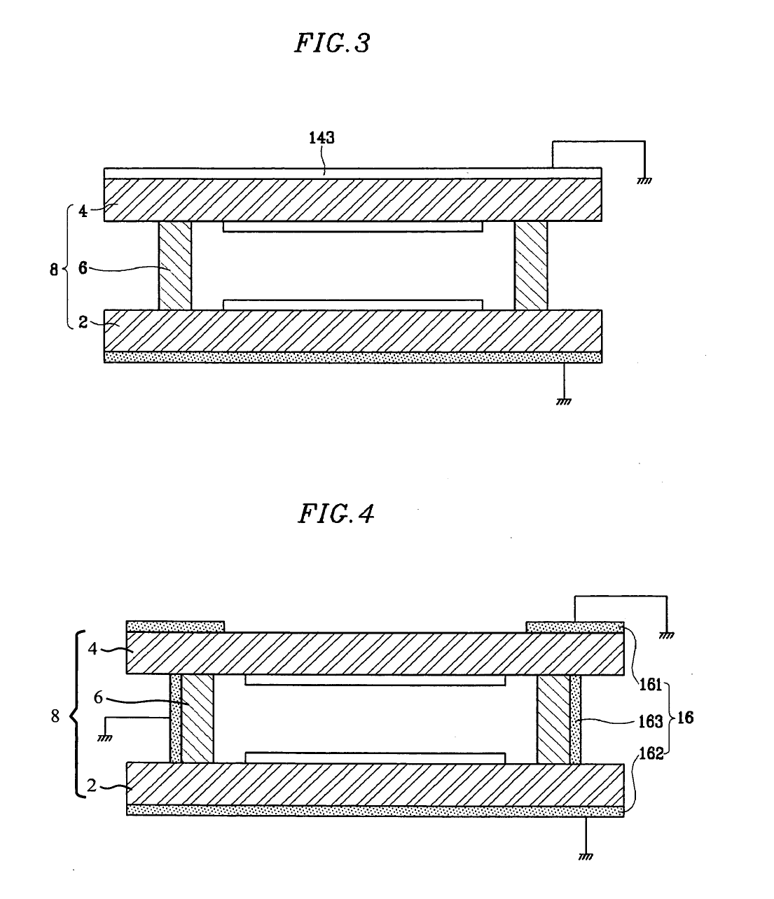

FIG. 1 is a cross-sectional view schematically showing an electron emission display device according to a first embodiment of the invention, and FIG. 2 is a planar view of the electron emission display device shown in FIG. 1.

With reference to FIG. 1, an electron emission display device according to the first embodiment of the invention comprises a first substrate 2 and a second substrate 4 disposed parallel to each other and separated from each other by a predetermined distance. A side member 6 is disposed at the edges of the first substrate 2 and the second substrate 4 so as to form a closed inner space together with the first substrate 2 and the second substrate 4. The closed inner space is exhausted to a vacuum degree of 10⁻⁶ torr. Accordingly, the first substrate 2, the second substrate 4, and the side member 6 form a vacuum envelope 8.

The side member 6 may be a bar type made of frit glass or a glass frame formed between the first substrate 2 and the second substrate 4 as a support member, and frit glass spread between the substrates 2 and 4 and the glass frame of the side member 6.

An electron emission unit 10 for emitting electrons and a light emission unit 12 for emitting visible rays due to the electrons are provided inside the vacuum envelope 8. In the case of FEA-type, SCE-type, MIM-type, and MIS-type electron emission display devices using a cold cathode, as shown in FIG. 1, the electron emission unit 10 is disposed on a surface of the first substrate 2 so as to emit electrons toward the second substrate 4, and the light emission unit 12 is disposed on a surface of the second substrate 4 facing the first substrate 2 so as to emit visible rays by excitation due to the electrons.

The first substrate 2 and the second substrate 4 are respectively demarcated into an active area A and a non-active area externally surrounding the active area A. Pixels are arranged at the active area A so as to display desired images. Accordingly, the electron emission unit 10 and the light emission unit 12 are located in the active area A of the first substrate 2 and in the active area A of the second substrate 4, respectively.

The electron emission display device according to the first embodiment of the invention includes a conductive layer 14 on the exterior surface of the vacuum envelope 8. As shown in FIG. 1, the conductive layer 14 includes an upper conductive layer 141 formed on the upper surface of the second substrate 4 and a lower conductive layer 142 formed on the lower surface of the first substrate 2. The upper conductive layer 141 and the lower conductive layer 142 are respectively connected to a ground voltage through a ground wire.

As shown in FIG. 2, the upper conductive layer 141 is formed external to the active area A of the second substrate 4, that is, formed along the edge of the second substrate 4. The reason why the upper conductive layer 141 is formed external to the active area A is as follows. If the upper conductive layer 141 is opaquely formed and located in the active area A, visible rays cannot be emitted outside the vacuum envelope so that the electron emission display device cannot perform light emission or image display.

The conductive layer 14 may be formed with conductive materials such as aluminium (Al), silver (Ag), copper (Cu), gold (Au), molybdenum (Mo), graphite, or any suitable combination thereof.

The conductive layer 14 may consist of adhesive tape so that the conductive layer 14 may be adhered to the substrate with ease.

The conductive layer 14 may have a specific resistance within the range of 0.1 to 100 Ωcm.

The upper conductive layer 141 may be located in the active area A if it is formed so as to be transparent.

FIG. 3 is a cross-sectional view schematically showing an electron emission display device according to a second embodiment of the invention.

As seen in FIG. 3, an upper conductive layer 143 is formed so as to be transparent and is located on the entire surface of the second substrate 4 including the active area A.

The conductive layer 143 may be formed on the first substrate 2 or the second substrate 4, or on both the first substrate 2 and the second substrate 4. The conductive layer 143 may be partially formed on the first substrate 2 or the second substrate 4, and may be altered in various manners as to area, location, etc.

Thus far, the conductive layer has been described as being located in the first substrate 2 and the second substrate 4, but the conductive layer may be formed on the side member 6.

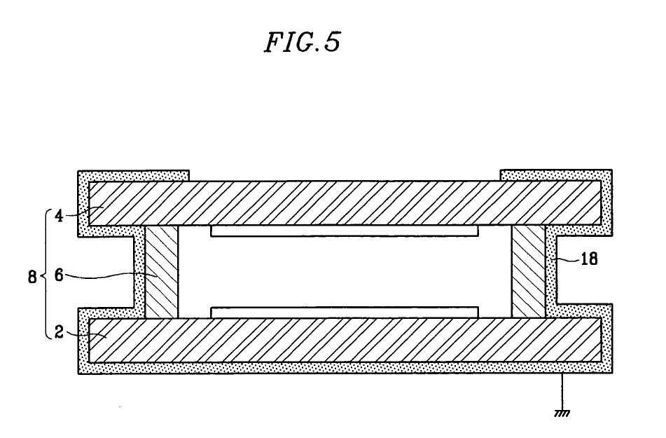

FIG. 4 is a cross-sectional view schematically showing an electron emission display device according to a third embodiment of the invention, and FIG. 5 is a cross-sectional view schematically showing an electron emission display device according to a fourth embodiment of the invention.

With reference to FIG. 4, the conductive layer 16 may include an upper conductive layer 161 formed on the second substrate 4, a lower conductive layer 162 formed on the first substrate 2, and a side conductive layer 163 formed on the outer side surface of the side member 6.

As shown in FIG. 4, the upper conductive layer 161, the lower conductive layer 162, and the side conductive layer 163 may be formed separately, but as shown in FIG. 5, the conductive layer 18 may be continuously formed on the vacuum envelope 8. In the case of the latter, it is unnecessary to connect the conductive layer 18 to a ground voltage through a separate ground wire.

As described in the latter embodiments, the conductive layers are formed on the exterior surface of the vacuum envelope 8, thereby discharging to the outside the static charge accumulated in the vacuum envelope 8.

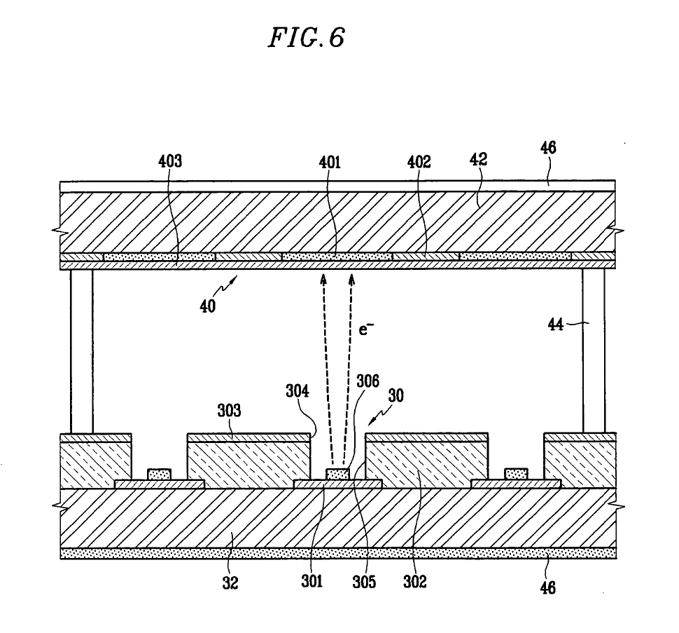

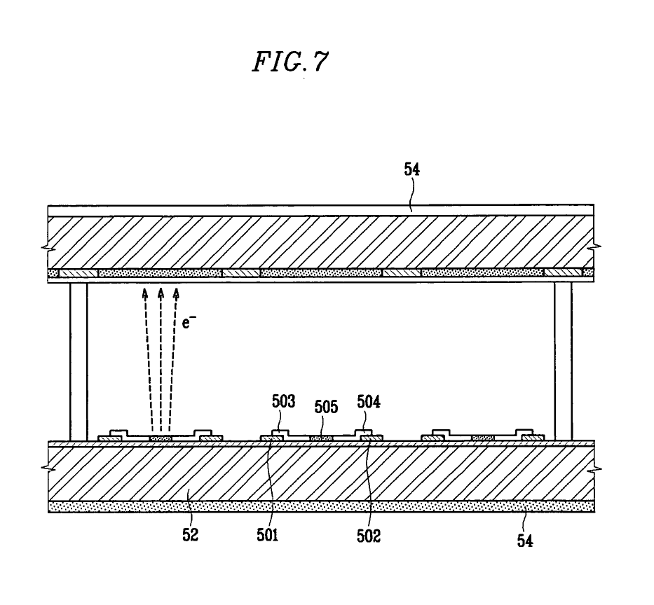

FIG. 6 is a cross-sectional view showing a field emission array (FEA) type of electron emission display device, and FIG. 7 is a cross-sectional view showing a surface-conduction emission (SCE) type of electron emission display device. FIG. 6 and FIG. 7 show electron emission units and light emission units which can be applied to the electron emission display device according to the present invention.

The internal structure of the FEA type of electron emission display device will be explained first with reference to FIG. 6.

The electron emission unit 30 includes cathode electrodes 301 which are stripe-patterned on the first substrate 32, an insulating layer 302 formed on the entire surface of the first substrate 32 while covering the cathode electrodes 301, and gate electrodes 303 which are stripe-patterned on the insulating layer 302 perpendicular to the cathode electrodes 301. Openings 304 and 305 are formed at the insulating layer 302 and the gate electrodes 303, respectively, so as to expose a portion of the cathode electrodes 301.

One or more electron emission regions 306 are formed on the cathode electrodes 301 within the openings 304 and 305. The electron emission regions 306 are formed of a material for emitting electrons under the application of an electric field, such as a carbonaceous material and a nanometer-sized material. The electron emission regions 306 may be formed with carbon nanotubes, graphite, graphite nanofiber, diamond, diamond-like carbon, fullerene (C₆₀), silicon nanowire, or any suitable combination thereof.

The light emission unit 40 includes phosphor layers 401 formed on a surface of the second substrate 42, black layers 402 placed between the phosphor layers 401, and an anode electrode 403 formed on a surface of the phosphor layers 401 and the black layer 402. The anode electrode 403 receives a high voltage from the outside so as to accelerate the electrons emitted from the electron emission regions 306.

Spacers 44 are provided between the first and second substrates 32 and 42, respectively, so as to sustain the distance therebetween.

The operation of the electron emission display device including a conductive layer 46 will be explained hereinafter.

When an anode voltage (usually several thousand volts) is applied to the anode electrode 403, a polarizing phenomenon is generated at the inner part of the second substrate 42. The second substrate 42, made of a material such as glass, is a dielectric substance. Accordingly, charges are at the inner part of the second substrate 42. With the anode voltage applied, positive charges (+) move to the exterior side of the second substrate 42 and accumulate, and negative charges (−) move to the interior side of the second substrate 42 and accumulate.

If the polarizing phenomenon continues, negative charges (−) opposite to the positive charges (+) which are accumulated at the exterior side of the second substrate 42 are accumulated at the exterior surface of the second substrate 42, thereby forming static charge. The static charge is discharged outside through the conductive layer 46 connected to the ground voltage. Due to the function of the conductive layer 46, the electron emission display device according to the embodiment of the invention inhibits the static charge from being accumulated in the vacuum envelope.

An SCE-type electron emission display device will be explained hereinafter. However, the SCE-type electron emission display device consists of the same configuration as the above FEA-type electron emission display device except for an electron emission unit provided to a first substrate.

With reference to FIG. 7, with the electron emission unit 50 of the SCE-type electron emission display device, first and second electrodes 501 and 502, respectively, are arranged on the first substrate 52 in parallel with each other with a distance therebetween, and first and second conductive thin films 503 and 504 are placed close to each other while partially covering the surface of the first and second electrodes 501 and 502. Electron emission regions 505 are disposed between the first and second conductive thin films 503 and 504, respectively, and are electrically connected to the first and second electrodes 501 and 502, respectively, through the first and second conductive thin films 503 and 504, respectively.

The first and second electrodes 501 and 502, respectively, may be formed of various conductive materials. The first and second conductive thin films 503 and 504, respectively, may be formed of micro-particles based on a conductive material, such as nickel, gold, platinum, and palladium. The electron emission regions 505 may be formed of carbon and/or one or more carbon compounds.

The operation of the SCE-type electron emission display device having the conductive layer 54 is the same as that of the FEA-type electron emission display device.

Among the electron emission display devices, the FEA-type and the SCE-type electron emission display devices are illustrated. However, the electron emission display device according to the present invention is not limited thereto. That is, the present invention may be applied to a vacuum fluorescent display as well as the MIM-type and the MIS-type electron emission display device.

As described above, the electron emission display device according to the present invention has a conductive layer on the surface of a vacuum envelope, thereby discharging the static charge accumulated in the vacuum envelope by means of the conductive layer outside. Accordingly, the present invention inhibits the static charge occurring on the vacuum envelope, and prevents arcing generated by the static charge.

Although exemplary embodiments of the present invention have been described in detail hereinabove, it should be clearly understood that many variations and/or modifications of the basic inventive concept herein taught, which may appear to those skilled in the art, will still fall within the spirit and scope of the present invention as defined in the appended claims.

What is claimed is:

1. An electron emission display device, comprising:
a first substrate and a second substrate facing each other;
a side member formed along edges of the first substrate and the second substrate to form, together with the first substrate and the second substrate, a vacuum envelope;
an electron emission unit provided on the first substrate for emitting electrons;
a light emission unit provided on the second substrate for emitting visible light as a result of the electrons from the electron emission unit; and
a conductive layer formed on at least a part of an exterior surface of the vacuum envelope and connected to a ground voltage for discharging static charge accumulated in the vacuum envelope.

2. The electron emission display device of claim 1, wherein the conductive layer is formed on an entirety of an exterior surface of the second substrate.

3. The electron emission display device of claim 2, wherein the conductive layer is additionally formed on an exterior surface of the first substrate.

4. The electron emission display device of claim 3, wherein the conductive layer is additionally formed on an outer side surface of the side member.

5. The electron emission display device of claim 4, wherein the conductive layer formed on the first substrate, the second substrate and the side member, respectively, comprises a continuous conductive layer.

6. The electron emission display device of claim 2, wherein the conductive layer is formed external to an active area set up in the second substrate.

7. The electron emission display device of claim 2, wherein the conductive layer is formed so as to be transparent.

8. The electron emission display device of claim 7, wherein the conductive layer is formed on an entirety of a surface of an active area set up in the second substrate.

9. The electron emission display device of claim 1, wherein the conductive layer is formed of at least one material selected from a group consisting of aluminum (Al), silver (Ag), copper (Cu), gold (Au), molybdenum (Mo), and graphite.

10. The electron emission display device of claim 1, wherein the conductive layer is adhesive tape.

11. The electron emission display device of claim 1, wherein the conductive layer has a specific resistance in a range of 0.1 to 100 Ωcm.

12. The electron emission display device of claim 1, wherein the electron emission unit comprises an electron emission region and a driving electrode for controlling the electron emission region.

13. The electron emission display device of claim 12, wherein the driving electrode comprises a cathode electrode and a gate electrode insulated from each other and intersecting each other.

14. The electron emission display device of claim 13, wherein the electron emission region is formed of at least one material selected from a group consisting of carbon nanotubes, graphite, graphite nanofiber, diamond, diamond-like carbon, fullerene (C₆₀), silicon nanowire, and combinations thereof.
